(19) United States
(12) Patent Application Publication
(10) Pub. No.: US 2021/0337635 A1
(43) Pub. Date: Oct. 28, 2021

(54) HEATING COIL DESIGN FOR WIRELESS POWER SYSTEMS

(71) Applicant: POWERMAT TECHNOLOGIES LTD., Petach Tikva (IL)

(72) Inventors: Itay Sherman, Hod-Hasharon (IL); Elieser Mach, Rosh Tzurim (IL)

(73) Assignee: POWERMAT TECHNOLOGIES LTD., Petach Tikva (IL)

(21) Appl. No.: 17/231,218

(22) Filed: Apr. 15, 2021

Related U.S. Application Data
(60) Provisional application No. 63/014,169, filed on Apr. 23, 2020.

(51) Int. Cl. H05B 6/06; H02J 50/12; H02J 50/60; H05B 6/12

(52) U.S. Cl. CPC H05B 6/062; H02J 50/12; H02J 50/60; H05B 2213/06; H05B 6/1272; H05B 2213/05; H05B 6/1236

(57) ABSTRACT

A power transmitter is provided herein. The power transmitter provides executing a dynamic heating operation with a heating object. The power transmitter senses a metallic structure in a presence of a coil of the power transmitter and transmits waves at one or more frequencies in response to sensing the metallic structure. The power transmitter determines that the metallic structure is the heating object based operation conditions respective to transmitting the waves and executes the dynamic heating operation by providing a power transfer to the heating object.

### PRIORITY CLAIM

This application claims priority to U.S. Provisional Patent Application Ser. No. 63/014,169, entitled “HEATING COIL DESIGN FOR WIRELESS POWER SYSTEMS,” which has a filing date of Apr. 23, 2020 and which is hereby incorporated by reference as if set forth in full in this application for all purposes.

### BACKGROUND

The disclosure relates generally to wireless power systems, and more specifically, to a heating coil design for wireless power systems.

In general, contemporary implementations of wireless power transfer methods provide for inductive power transfer between a power transmitter (Tx) and a power receiver (Rx) without the need of physical connections or cords. Further, contemporary wireless power transfer methods have become common solution in market and can be designed according to a Qi specification (e.g., using inductive wireless power transmission). For example, the Tx is designed to operate with Qi based Rx to transfer inductive power for charging and operation of consumer devices that are coupled to or include the Qi based Rx.

It has been found that, in many cases, foreign metallic objects may unintentionally heat up during the transfer of the inductive power. In turn, attempts have been made to use this heating operation purposefully. In an example, inductive cooktops provide a magnetic field created by the Tx that is absorbed and turned into heat by metal objects (e.g., a frying pan). Generally, the Tx is operated in a continuous power mode that sends out a magnetic field. The magnetic field heats metal objects (whether in the Tx or the Rx) and does not wait for any specific response from the Rx. In turn, the Tx may also include a triggering mechanism to enable the magnetic field and/or the heating operation, such as when only a metal object is present or when a foreign object and an object that should intentionally be heated is differentiated.

Yet, while a triggering mechanism may control the magnetic field and/or the heating operation, there is presently no solution to optimize the inductive power transfer and heat creation. Due to this lack of control, as a large percentage of the inductive power and the heat is created in the Tx itself (as opposed to be generated on the Rx). Such heating of items on the Tx can be limited by design and choice of materials (e.g., due to foreign object unintentional heating, most of the transmitters are made of non-metallic materials, usually some kind of plastic which can only tolerate limited temperatures before deformation or damage).

It would be beneficial to use the magnetic field for heating objects, such as coffee mugs or other items. To achieve this use, it is crucial to optimize heat generated to heat mostly the item to be heated and less the Tx or anything else. Thus, there is a need to improve wireless power systems.

### SUMMARY

According to one embodiment, a power transmitter is provided. The power transmitter provides executing a dynamic heating operation with a heating object. The power transmitter senses a metallic structure in a presence of a coil of the power transmitter and transmits one or more waves at one or more frequencies in response to sensing the metallic structure. The power transmitter determines that the metallic structure is the heating object based operation conditions respective to transmitting the one or more waves and executes the dynamic heating operation by providing a power transfer to the heating object.

According to one or more embodiments, the power receiver embodiment above can be provided can be implemented as a system, a method, an apparatus, or a computer program product, along with as a power transmitter.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 shows a block diagram depicting a system in accordance with one or more embodiments;

FIG. 2 depicts a block diagram depicting a system in accordance with one or more embodiments;

FIG. 3 depicts a coil design in accordance with one or more embodiments;

FIG. 4 depicts a method of a system in accordance with one or more embodiments;

FIG. 5 depicts a method of a system in accordance with one or more embodiments;

FIG. 6 depicts a foil design in accordance with one or more embodiments.

### DETAILED DESCRIPTION

Embodiments disclosed herein may include apparatuses, systems, methods, and/or computer program products (generally discussed herein as a system) that provide a heating coil design for wireless power systems that is capable of heating and sensing a state of a power receiver (Rx).

According to one or more embodiments, a low cost heating design for the system operates a power transmitter (Tx) in an efficient way to optimize power transfers to a power receiver (Rx), such as an object for heating. Further, in an embodiment, the Rx can provide a unique ‘signature’ to the Tx that allows the Tx to recognize the Rx as an object for heating and to activate the power transfer for heat only. For example, the Tx activates the power transfer for heat only when these specific objects are placed on a surface of the Tx, rather than any random foreign metal object.

One exemplary implementation provides a Tx that senses a metallic structure in a presence of a coil of the power transmitter and transmits one or more waves at one or more frequencies in response to sensing the metallic structure. The Tx can further determine that the metallic structure is the heating object based operation conditions, subsequent to transmitting the one or more waves at the one or more frequencies, and execute the dynamic heating operation by providing a power transfer to heat a coil of the heating object. That is, the Tx operates smartly in view of operation conditions to optimize the dynamic heating operation and the power transfer. The operation conditions can include receiving a signature of the coil of the heating object that would allow the Tx to control an amount of the power transfer to the heating object in a precise way. The coil of the heating object can be a heating coil designed for wireless power systems, such that the heating coil provides optimal heat with respect the dynamic heating operation and the power transfer. In an example, the coil of the Tx can be designed to create heat on the heating coil, and the heating coil can be constructed of aluminum or alumni foil and/or be closed on itself with enough resistance to achieve the optimal heat.

According to one or more advantages, technical effects, and benefits, the system thus enables the Tx to charge a device (e.g., a phone) based on charging protocols, while refraining from foreign object undesired heating, and enables specific items carrying a specific signature to be heated. One or more of the applications contemplated by the system include, but are not limited to warming a drink, such as coffee or tea; baking or heating a cup cake freshly and directly on the Tx; popping popcorn; warming baby bottles; and maintaining temperatures in a medical environment. Embodiments described herein are necessarily rooted in one or more controllers of the Tx and Rx of the system to perform proactive operations to overcome problems specifically arising in the realm of heating coil designs for wireless power systems.

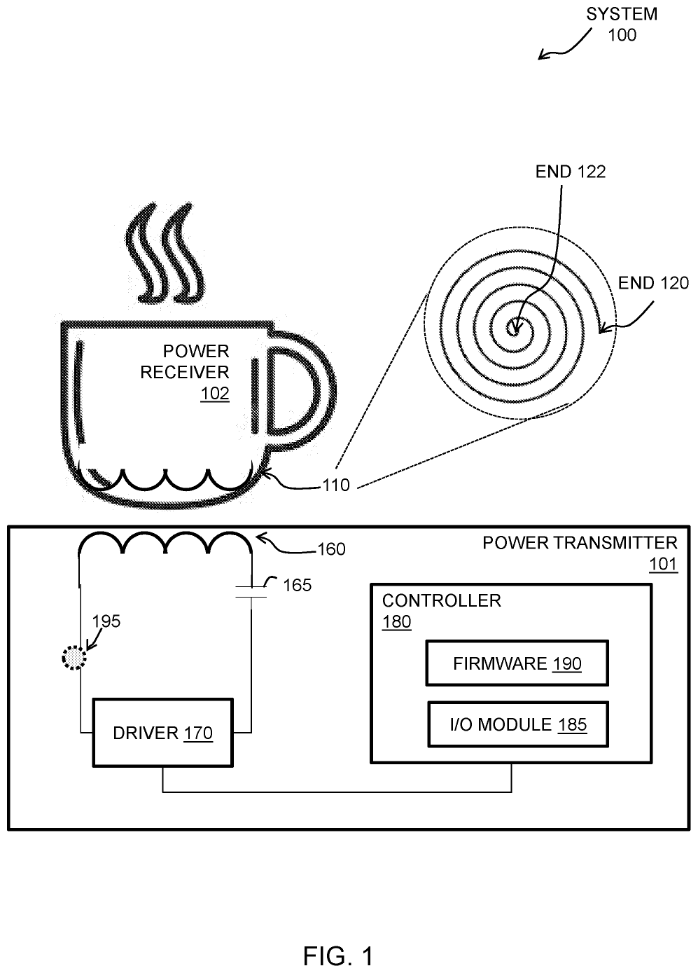

FIG. 1 shows a block diagram depicting a system 100 in accordance with one or more embodiments. The system comprises a power transmitter 101 and a power receiver 102 (referred herein as Tx 101 and Rx 102, respectively). The Tx 101 is any device that can generate electromagnetic energy to a space around the Tx 101 that is used to provide power to the Rx 102. The Rx 102 is any device that can receive, use, and/or store the electromagnetic energy when present in the space around the Tx 101. Note that the Tx 101 can have a similar or the same component structure as the Rx 102, and vice versa.

In FIG. 1, the Rx 102 includes circuitry for receiving and storing the electromagnetic energy, such as a resonance coil 110. The resonance coil 110 can be a spiral metal member inlaid within an object, such as a coffee mug. The resonance coil 110 can begin at an end 120, run a length of the spiral to another end 122 (e.g., thereby making at least one layer). According to one or more embodiments, the end 120 and the end 122 of the resonance coil 110 can be connected to each other with no other components therebetween, such as by being welded or the like.

The circuitry of the Rx 102 may also include a load, a thermistor, a parallel resonance capacitor; a serial resonance capacitor; a switch; a controller; and a rectifier. In accordance with some example embodiments, the Rx 102 may be used to wirelessly obtain induced power from the Tx 101 for supplying power to or for charging the load, examples of which include handheld battery, a power supply, a combination thereof, and the like. Additionally, the Rx 102 may be capable of wirelessly communication with the Tx 101 (e.g., in-band communication). According to one or more embodiments, a resonate section (circuit) of the Rx 102 can include the resonance coil 110 covered with ferrite, and the capacitors, a power-supply section of the Rx 102 can include the rectifier, the load, and the switch, and a control and communication section of the Rx 102 can include the controller.

According to one or more embodiments, the thermistor, generally, is a resistor with variable resistance according to temperature. A thermistor temperature coefficient can be selected as to yield a noticeable change (e.g., 10%) in an overall coil resistance across a relevant operational temperature. According to one or more embodiments, the thermistor and/or one or more capacitors can be connected in series with the resonance coil 110 or in parallel with the resonance coil 110. For example, a capacitor with high temperature coefficient may be connected in series with the thermistor and/or the resonance coil 110. The capacitance of the capacitor can be changed with temperature and an effective impedance of the resonance coil 110 and resonance frequency can be modified and sensed by the Tx 101. The values of the resonance circuit components are defined to match with a transmitted frequency of the Tx 101. The Rx 102 can be provided with or without the capacitor.

The Tx 101 includes circuitry for generating and transmitting the electromagnetic energy (e.g., transmitting power). The circuitry of the Tx 101 may include a coil 160; a capacitor 165; a driver 170; and a controller 180, which further include an input/output (I/O) module 185 and firmware 190. The coil 160 and the capacitor 165 provide an LC circuit for generating an inductive current in accordance with operations of the driver 165 and the controller 180 to support power transmissions.

According to one or more embodiments, the controller 180 may utilize the I/O module 185 as an interface to transmit and/or receive information and instructions between the controller 180 and elements of the Tx 101 (e.g., such as the driver 170 and a wiring junction 195). Note that the controller 180 can include a central processing unit (CPU) based on a microprocessor, an electronic circuit, an integrated circuit, and/or implemented as special firmware ported to a specific device such as a digital signal processor, an application specific integrated circuit, and any combination thereof, or the like. According to one or more embodiments, the controller can be utilized to perform computations required by the Tx 101 or any of the circuitry therein.

According to one or more embodiments, the controller 180 may sense, through the I/O module 185 one or more currents or voltages, such as a DC input voltage (Vin) and a DC output voltage (Vout). According to one or more embodiments, the controller 180 can activate, through the I/O module 185, one or more switches to change the resonance frequency.

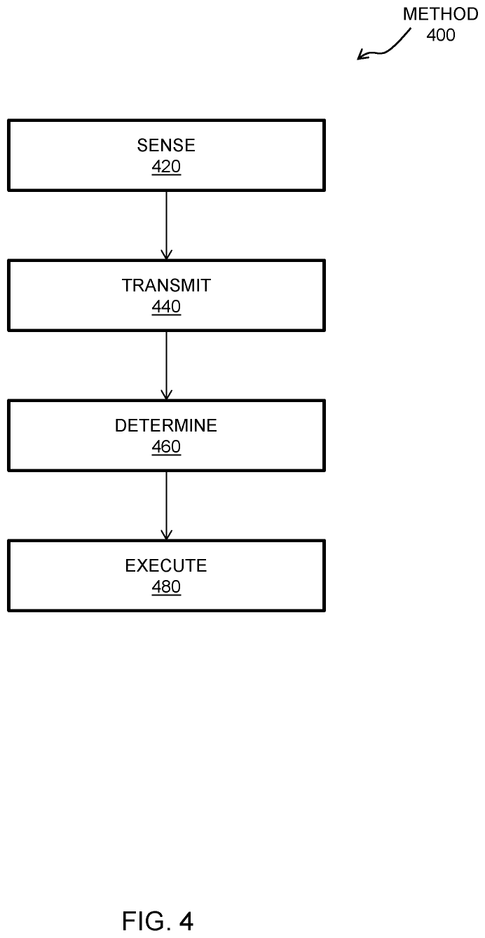

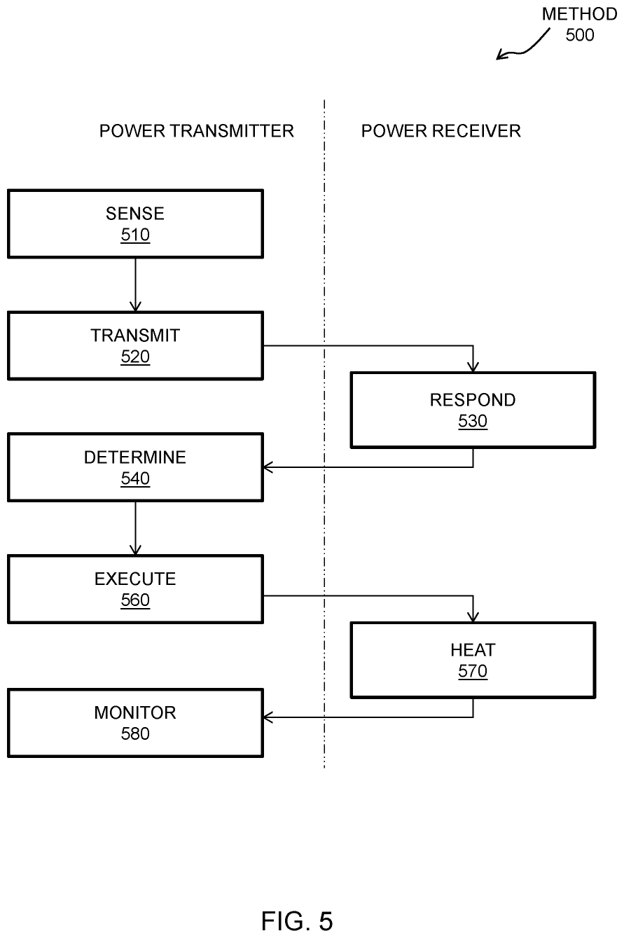

According to one or more embodiments, the controller 180 may utilize the firmware 190 as a mechanism to operate and control operations of the Tx 101. In this regard, the controller 180 can be a computerized component or a plurality of computerized components adapted to perform methods such as depicted in FIGS. 4-5. For example, the controller can include a computer program product that stores a computer readable storage medium (e.g., implementing methods such as depicted in FIGS. 4-5). According to one or more embodiments, the controller 180 can also cause the system 100 to participate in in-band communications.

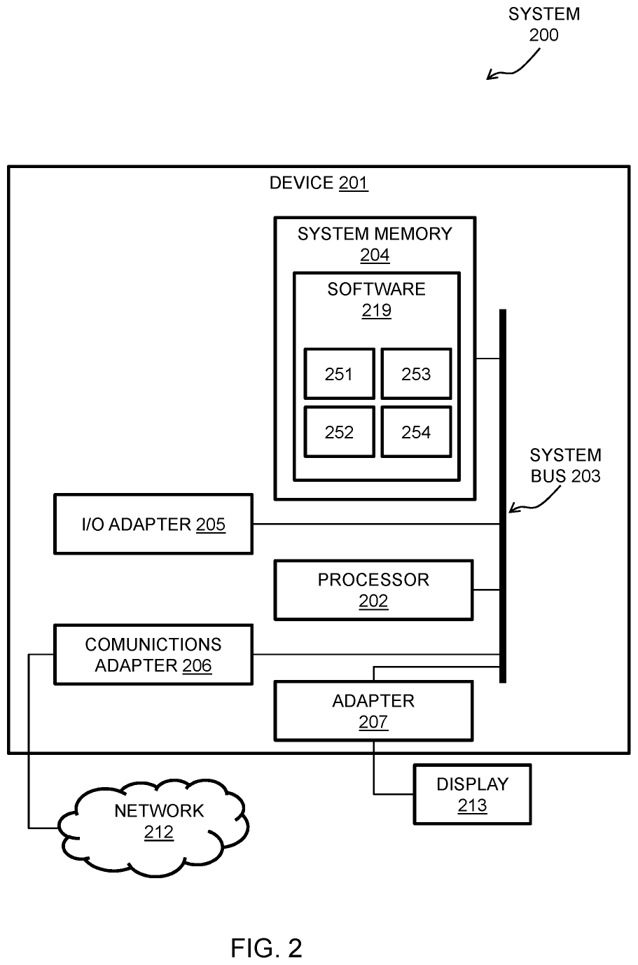

FIG. 2 depicts an example of a system 200 in accordance with one or more embodiments. The system 200 has a device 201 (e.g., the Rx 102 and/or the Tx 101 of the system 100 of FIG. 1) with one or more central processing units (CPU(s)), which are collectively or generically referred to as processor(s) 202 (e.g., the controller 180 of FIG. 1). The processors 202, also referred to as processing circuits, are coupled via a system bus 203 to system memory 204 and various other components. The system memory 204 can include a read only memory (ROM), a random access memory (RAM), internal or external Flash memory, embedded static-RAM (SRAM), and/or any other volatile or non-volatile memory. For example, the ROM is coupled to the system bus and may include a basic input/output system (BIOS), which controls certain basic functions of the device 201, and the RAM is read-write memory coupled to the system bus 203 for use by the processors 202.

FIG. 2 further depicts an I/O adapter 205, a communications adapter 206, and an adapter 207 coupled to the system bus 203. The I/O adapter 205 may be a small computer system interface (SCSI) adapter that communicates with a drive and/or any other similar component. The communications adapter 206 interconnects the system bus 203 with a network 212, which may be an outside network (power or otherwise), enabling the device 201 to communicate data and/or transfer power with other such devices (e.g., such as the Tx 101 connecting to the Rx 102). A display 213 (e.g., screen, a display monitor) is connected to the system bus 203 by the adapter 207, which may include a graphics controller to improve the performance of graphics intensive applications and a video controller. Additional input/output devices cab connected to the system bus 203 via the adapter 207, such as a mouse, a touch screen, a keypad, a camera, a speaker, etc.

In one embodiment, the adapters 205, 206, and 207 may be connected to one or more I/O buses that are connected to the system bus 203 via an intermediate bus bridge. Suitable I/O buses for connecting peripheral devices such as hard disk controllers, network adapters, and graphics adapters typically include common protocols, such as the Peripheral Component Interconnect (PCI).

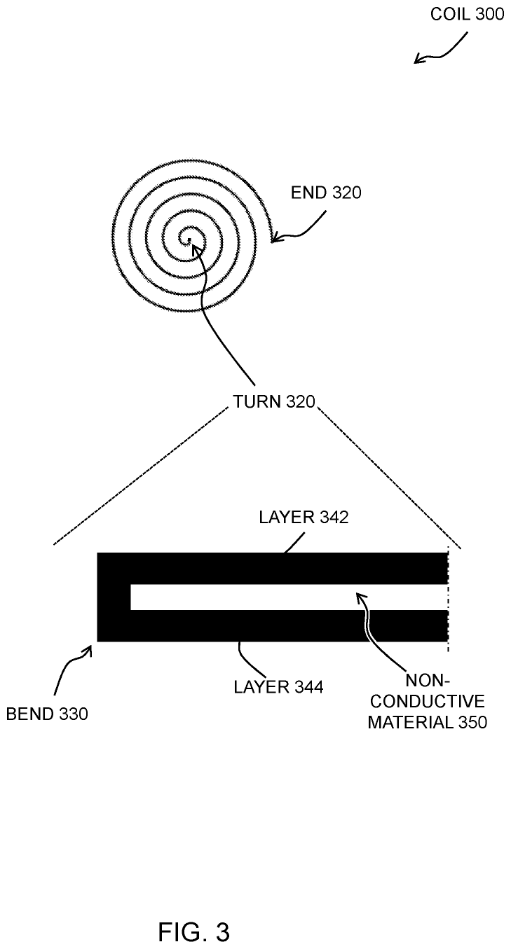

The system memory 204 is an example of a computer readable storage medium, where software 219 can be stored as instructions for execution by the processor 202 to cause the device 201 to operate, such as is described herein with reference to FIGS. 3-4. In connection with FIG. 1, the software 219 can be representative of firmware 190 for the Tx 101, such that the memory 204 and the processor 202 (e.g., the controller 180) logically provide a FIR equalizer 251, an analyzer 252 of in-band communication data, a selector for selecting a ping, a coupler 253 for dynamically determining a coupling factor, a regulator 254 for dynamically determining an operating frequency, etc.

Turning now to FIG. 3, a coil design 300 (e.g., the resonance coil 110 of the Rx 102 of FIG. 1) is depicted in accordance with one or more embodiments. The coil design 300 can be a winding, such as a spiral winding greater than one (e.g., 7 or 10 windings). According to one or more embodiments, the coil design 300 is a spiral coil with 10 windings of 50 mm diameter and trace width of 1 mm, having self-inductance of 3.7 μH. According to one or more embodiments, the coil design 300 can be built into a cup, a mug, a pan, a container, a surface, a bottle, and/or a medical environment.

The coil design 300 can also be folded over itself, such that the coil design 300 begins at end 310, runs a length of the spiral to a turn 320, reverses/bends 330 at the turn 320, and returns through the length of the spiral to the end 310 (e.g., thereby making two layers 342 and 344). The two layers can be separated by a non-conductive material 350. According to one or more embodiments, the coil design 300 is formed in two separated layers, each of 10 windings, and then connected by a welding or the like at the turn 320 to form a single coil with current flowing on both layers in same spiral direction. The formed two layer coil can have an inductance of 12 μH.

According to one or more embodiments, the coil design 300 can be a heating object design based on creation of a coil with both ends 310 electrically shorted. In turn, the coil design 300 acts as a receiver for magnetic field from (e.g., the coil 160 of the Rx 102 of FIG. 1) as well as a load (e.g., the load of the Rx 102 of FIG. 1) that consumes absorbed energy to generate a desired heat. The coil design 300 can be made of low cost materials, such as one or more aluminum foils. As an example, a cooking aluminum foil of 14 um thickness can be used to form the coil design 300.

The inductance of the coil design 300 can be designed to achieve range of inductances, such as with standard Qi receivers to allow the Tx 101 to operate at designed operation points and to provide a designed power transfer. According to one or more embodiments, the range of inductances can include 3 uH to 20 uH.

FIG. 4 depicts a method 400 of a system (e.g., the system 100 of FIG. 1) in accordance with one or more embodiments. FIG. 4 is described with reference to FIGS. 1-3 for ease of explanation. For instance, the method 400 illustrates how the Tx 101 and the Rx 102 interact to provide a wireless power heating coil system design (e.g., the system 100) that is capable of heating the resonance coil 110 (e.g., the coil design 300 of FIG. 3) and sensing a state of the Rx 102. In general, wave transmissions are used to perform a detection by the Tx 101 of a metallic structure (e.g., the Rx 102), and these same wave transmission and/or with additional transmissions are used to analyze by the Tx 101 properties of the metallic structure to determine if the metallic structure is a designated heating object. More particularly, the method 400 can be executed by the controller 180 after the Rx 102 is presented to the Tx 101 in the space around the Tx 101. The controller 180 can utilize the firmware 190, which embodies the method 400 as code, as a mechanism to operate and control operations of the Tx 101, such as wave transmissions.

The method 400 begins at block 420, where the Tx 101 that senses a metallic structure in a presence of the coil 160 of the Tx 101. At block 440, the Tx 101 transmits one or more waves at one or more frequencies. The intent of this transmission by the Tx 101 is to trigger a reaction in the metallic structure. Thus, the transmission by the Tx 101 can be in response to sensing the metallic structure.

At block 460, the Tx 101 determines that the metallic structure is the heating object. The heating object can be a passive or active device. According to one or more embodiments, the heating object can be the Rx 102 in its entirety, such that a controller can interact based on firmware with the Tx 101. According to one or more embodiments, the heating object can also be a select number of components of the Rx 102, such as the resonance coil 110 (e.g., implemented as the coil design 300), the thermistor, and/or the capacitor with high temperature coefficient. This determination by the Tx 101 can be in response to the transmitting the one or more waves at the one or more frequencies, such that changes in the operation conditions are detected and analyzed by the Tx 101 to make such a determination. Operation conditions can include, but are not limited to, a signature, decay frequency, decay factor, a current flow, a coupling factor, and/or a temperature.

According to one or more embodiments, the Tx 101 can recognize the heating object in various operations, such as by measuring decay frequency and\or decay factor of a predetermined energetic ping or pings (e.g., the one or more waves at the one or more frequencies). As another example, the Tx 101 can perform a low energy scan on multiple operational frequencies (e.g., the one or more waves at the one or more frequencies). The low energy scan can include a fixed driving voltage and duty cycle to the driver 170. The Tx 101 can then measure a current flow through the coil 160. Based on the assumption that the heating object is coupled, and given that component responses of the Tx 101 are known (e.g., inductances, resonant capacitances, and parasitic resistances stored in the firmware 190), a coupling factor k to the heating object can be derived for each measured frequency. For instance, the Tx 101 can derive the coupling factor k based on a measured current using Equation 1 (e.g., stored as part of the firmware 190).

$$\vert \frac{V}{I} \vert = \sqrt{\begin{matrix}{wlp - \frac{1}{wCp} + \frac{{k}^{2} {w}^{2} LpLs ( wls - \frac{1}{wCs} )}{{( wls - \frac{1}{wCs} )}^{2} + {Rl}^{2}} )}^{2} + \\ {( Rp + \frac{{k}^{2} {w}^{2} LpLsRl}{{( wls - \frac{1}{wCs} )}^{2} + {Rl}^{2}} )}^{2}\end{matrix}} \qquad Equation 1$$

Note that when all results agree or with minimal error, the Tx 101 has determined with high probability that the metallic structure on the surface is indeed the heating object.

At block 480, the Tx 101 determines execute the dynamic heating operation by providing a power transfer to heat a coil of the heating object. The dynamic heating operation of the Tx 101 can include use any preferred strategy to control the power transfer and to implement any desired limitation on a temperature of the heating object. According to one or more embodiments of the dynamic heating operation, the Tx 101 measures a temperature of the eating object and modifies the power transfer as to maintain the temperature of heating object as a defined temperature range. Note that the Tx 101 using Equation 1 can determine a resistance of the heating object and, based on a variation of the resistance, can determine a temperature of the heating object.

FIG. 5 depicts a method 500 of a system (e.g., the system 100 of FIG. 1) in accordance with one or more embodiments. FIG. 5 is described with reference to FIGS. 1-3 for ease of explanation. For instance, the method 500 illustrates how the Tx 101 and the Rx 102 interact to create more efficient power transfer and avoid a power loss on the Tx 101. More particularly, the method 500 can be executed by the controller 180 after the Rx 102 is presented to the Tx 101 in the space around the Tx 101. The controller 180 can utilize the firmware 190, which embodies the method 500 as code, as a mechanism to operate and control operations of the Tx 101.

The method 500 begins at block 510, where the Tx 101 senses a metallic structure in a presence of the coil 160 of the Tx 101. Generally, as discussed herein, the Tx 101 includes the coil 160 that is designed to create heat on the resonance coil 110 of the heating object (e.g., the Rx 102, which represents a mug, a medical device, or the like) and operates smartly using firmware 190 in view of operation conditions to optimize the dynamic heating operation and the power transfer. In this way, based on the firmware 190, the controller 180 can utilize the I/O module 185 to sense and/or receive information from any of the components of the Tx 101 (e.g., such as the driver 170 and a wiring junction 195). This information indicates that something metallic (e.g., the metallic structure) has appeared with an inductive range of the coil 160. The inductive range is a distance range within which a metal can cause a change in a magnetic field of the coil 160. The subsequent operations of the method 500, in turn, attempt to discover further data (block 520), analyze that data (block 540), and provide dynamic heating operations (580).

Thus, turning to block 520, the Tx 101 transmits one or more waves at one or more frequencies. Transmitting the one or more waves is how the Tx 101 discovers that it is operating against a heating object, such a heating coil of a mug designed for wireless power systems.

At block 530, the Rx 102 responds. The response can be active or passive. In the case of a passive response, the Rx 102 merely changes the magnetic field of the coil 160 by being present within the inductive range. In the case of an active response, the Rx 102 can send a signal, a ping, data, or the like through in-band communication to the Tx 102, each of which can identify the Rx 102.

At block 540, the Tx 101 determines that the metallic structure is the heating object. This determination by the Tx 101 can be reactive to the active or passive interaction by the Rx 102, such that changes in the operation conditions are detected and analyzed by the Tx 101 to make such a determination. The operation conditions can include a signature of the resonance coil 110 of the Rx 102 that would allow the Tx 101 to control (blocks 5860 and 580) an amount of the power transfer to the Rx 102 in a precise way. Items with different signatures can be utilizes for different amounts of power to be dissipated in each item. For example, a small coffee mug requires less energy to keep a drink at a certain temperature than a larger mug and a signature of each can dictate which heating object is determined by the Tx 101. As another example, the Rx 102 can change a signature depending on the amount of liquid in the mug or based on other logic.

At block 560, the Tx 101 determines execute the dynamic heating operation. The dynamic heating operation can include at least providing a power transfer to heat the resonance coil 110 of the heating object (e.g., the Rx 102). A thermistor of the RX 102 can control the heat on the Rx 102, such that resistance can change as temperature change. Further, inductance can chance with respect to capacitance as well.

At block 570, the Rx 102 heats. According to one or more embodiments, based on the power transfer, a generated current heats the resistance of the resonance coil 110 and is consumed by whatever object is intended to be heated (e.g., liquid in a mud). In an example, the resonance coil 110 can be constructed of aluminum or alumni foil and/or be closed on itself with enough resistance to achieve an optimal heat.

According to one or more embodiments, formed coils (e.g., the coil design 300) have an impedance that includes a real component and an imaginary component. The real component is an ohmic resistance for AC current that can be approximated by Equation 2, were ρ is a resistivity (of aluminum), δ is a skin depth for an operation frequency of the Tx 101 (e.g., assuming the skin depth is smaller than A width of a foil), and t is foil thickness.

R=2ρl/δt Equation 2

The approximation of equation 2 is relevant if a proximity effect between coil windings is insignificant. For cases were proximity effect is significant, an effective skin depth is reduced and ohmic resistance is increased.

The imaginary component is defined by Equation 3, were ω is angular frequency of a magnetic field, L the inductance of the formed coil, and i is an imaginary square root of negative one.

X=iωL Equation 3

To maximize the power transfer, the real component is driven to be equal or approximate to the imaginary component, as this would provide the highest heat power dissipating from the resonance coil 110 for a given magnetic field generated by the Tx 101. By way of example, for a single layer coil, a real AC resistance is about 0.7 ohm (e.g., calculated based on Equation 1), while an imaginary resistance when operating at typical Qi frequencies of 140 kHz can be ˜3.5 ohm. To match the imaginary resistance, the resonance coil 110 can include a foil extension (e.g., an extension of the aluminum foil that is intended to operate as a resistor only, with minimal inductance contribution).

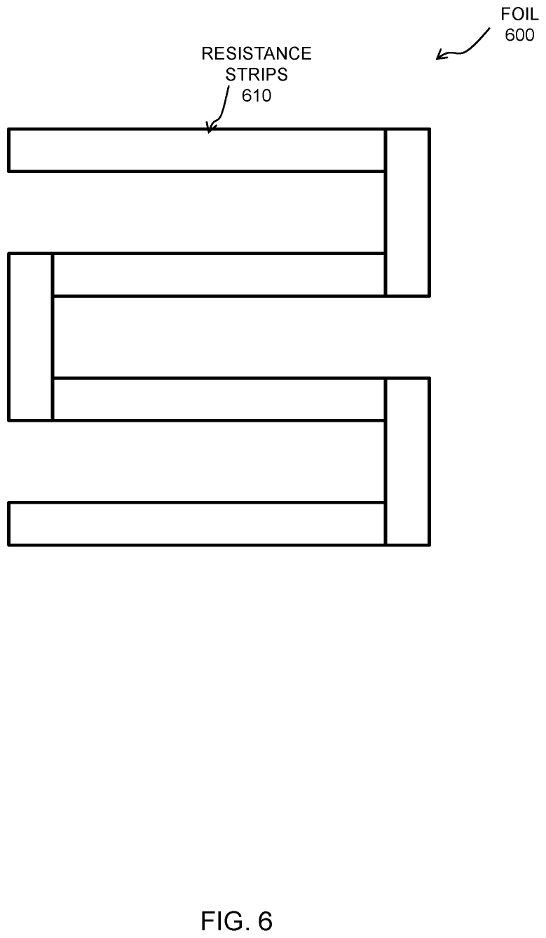

In FIG. 6, a foil design 600 is depicted in accordance with one or more embodiments. The foil design 600 comprises one or more resistance strips or foil strips 610. The resistance strips 610 can be configured to go back and forth in opposite directions, so current flowing through the resistance strips 610 flows in opposite direction to cancel inductance contributions from the resistance strips 610.

According to one or more embodiments, to increase resistivity, a gap between coil windings can be lowered to increase a proximity effect that would lower effective conductions depth and increase resistance. According to one or more embodiments, the resonance coil 110 can be formed in two layers, as discussed herein, with a trace thickness of 2 mm, 0.5 mm gap, an additional trace extension going back forth to achieve overall inductance of 12 uH, and a complex resistance of Z=11 i+11 (for operation at 140 kHz) were the 11 i is derived from Equation 3 and 11 is derived based on above AC resistance calculation of the coil plus the added trace. For any of the coil designs herein, and for an operation of a Qi transmitter with an inductance of 12 uH and a coupling of 0.5, the resonance coil 110 can achieve ˜10 W of heat dissipation for a current flow of ˜3 A RMS in the coil 160 (e.g., which is a standard operation point for the Tx 101 and provides low loss on the transmitter parasitic resistances (˜2 W)). Thus, embodiments herein can generate relatively low undesired heat in the Tx 101 while maximizing the heat delivered or dissipated via the resonance coil 110.

At block 580, the Tx 101 monitors. According to one or more embodiments, the Tx 101 compares the heat on the resonance coil 110 to an ambient or another reference temperature be important in cases were a difference in temperature may be more important than the absolute temperature. Accordingly, the Tx 101 can adjust the dynamic heating operation in view of this comparison to prevent overheating or damage to the Rx 102.

As indicated herein, embodiments disclosed herein may include apparatuses, systems, methods, and/or computer program products at any possible technical detail level of integration. The computer program product may include a computer readable storage medium (or media) having computer readable program instructions thereon for causing a controller to carry out aspects of the present invention.

The computer readable storage medium can be a tangible device that can retain and store computer readable program instructions. The computer readable storage medium may be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions described herein can be communicated and/or downloaded to respective controllers from an apparatus, device, computer, or external storage via a connection, for example, in-band communication. Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The flowchart and block diagrams in the drawings illustrate the architecture, functionality, and operation of possible implementations of apparatuses, systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the flowchart and block diagrams in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used herein, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A power transmitter executing a dynamic heating operation with a heating object, the power transmitter configured to:
sense a metallic structure in a presence of a coil of the power transmitter;
transmit one or more waves at one or more frequencies in response to sensing the metallic structure;
determine that the metallic structure is the heating object based operation conditions respective to transmitting the one or more waves; and
execute the dynamic heating operation by providing a power transfer to the heating object.

2. The power transmitter of claim 1, wherein the one or more waves at the one or more frequencies comprises at least one low energy scan on multiple operational frequencies.

3. The power transmitter of claim 1, wherein the one or more waves at the one or more frequencies comprises at least one predetermined energetic ping.

4. The power transmitter of claim 3, wherein the determining of the heating object comprises measuring a decay frequency or a decay factor of the at least one predetermined energetic ping.

5. The power transmitter of claim 1, wherein the determining of the heating object comprises detecting and analyzing changes in the operation conditions.

6. The power transmitter of claim 1, wherein the operation conditions comprise a signature, decay frequency, decay factor, a current flow, a coupling factor, or a temperature.

7. The power transmitter of claim 1, wherein the determining of the heating object comprises deriving a coupling factor to the heating object for each of the one or more frequencies.

8. The power transmitter of claim 1, wherein the heating object comprises a coil and a thermistor.

9. The power transmitter of claim 1, wherein the heating object comprises a coil design with one or more windings.

10. The power transmitter of claim 1, wherein the heating object comprises a first layer and a second layer connected at a turn and separated by a non-conductive material.

11. The power transmitter of claim 10, wherein the first layer and the second layer form a single coil with a current flowing on the first and second layers in same spiral direction.

12. The power transmitter of claim 1, wherein a system comprises the power transmitter and the heating object.

13. A heating object executing a dynamic heating operation with a power receiver, the heating object configured to:
cause the power receiver to sense a metallic structure in a presence of a coil of the power transmitter;
receive one or more waves at one or more frequencies;
provide operation conditions respective to the one or more waves to cause the power transmitter to determine that the metallic structure is the heating object; and
executing the dynamic heating operation by receiving a power transfer to the heating object.

14. The heating object of claim 13, wherein the one or more waves at the one or more frequencies comprises at least one low energy scan on multiple operational frequencies.

15. The heating object of claim 13, wherein the one or more waves at the one or more frequencies comprises at least one predetermined energetic ping.

16. The heating object of claim 13, wherein the operation conditions comprise a signature, decay frequency, decay factor, a current flow, a coupling factor, or a temperature.

17. The heating object of claim 13, wherein the heating object comprises a coil and a thermistor.

18. The heating object of claim 13, wherein the heating object comprises a coil design with one or more windings.

19. The heating object of claim 13, wherein the heating object comprises a first layer and a second layer connected at a turn and separated by a non-conductive material.

20. The heating object of claim 19, wherein the first layer and the second layer form a single coil with a current flowing on the first and second layers in same spiral direction.
